(19) United States
(12) Patent Application Publication
(10) Pub. No.: US 2020/0122909 A1
(43) Pub. Date: Apr. 23, 2020

(54) SHIPPING CONTAINER INTERNALLY LINED WITH COMPOSTABLE OR RECYCLABLE MATERIAL

(71) Applicant: Vericool, Inc., Livermore, CA (US)

(72) Inventor: Darrell Jobe, Livermore, CA (US)

(21) Appl. No.: 16/172,574

(22) Filed: Oct. 26, 2018

Related U.S. Application Data
(60) Provisional application No. 62/748,193, filed on Oct. 19, 2018.

(51) Int. Cl. B65D 65/46; B65D 5/02; B65D 81/38

(52) U.S. Cl. CPC B65D 65/466; B32B 3/28; B65D 81/3823; B65D 5/0281

(57) ABSTRACT

A panel that can be assembled into a container includes a unitary outer wall formed of recyclable plant-fiber pulp and pre-cut to be folded into a box, and one or more pads laminated to the outer wall and covering portions of the outer wall that when folded into the box provide sidewalls and floor of the box such that the pads cover interior surfaces of the sidewalls of the box. Each pad includes a thermally insulative layer of starch and/or cellulose and/or plant fiber pulp.

### CROSS-REFERENCE TO RELATED APPLICATIONS

This application claims priority to U.S. Provisional Application Ser. No. 62/748,193, filed Oct. 19, 2018, the entire disclosure of which is incorporated by reference.

### TECHNICAL FIELD

This invention relates to an insulated shipping container, and more particularly to a shipping container lined with a compostable insulating material.

### BACKGROUND

A conventional container for shipping temperature sensitive products includes a cardboard box, inside of which is a thermally insulating material. A conventional thermally insulating material is expanded polystyrene (EPS), e.g., Styrofoam. For example, panels of the expanded polystyrene can line the walls of the box, and another packing material, e.g., bubble wrap, can be placed surround and cushion the item being shipped inside the panels. Alternatively, expanded polystyrene can be machined or molded to form a “cooler” into which the item being shipped can be placed—this does not need an external box. In either case, a coolant, e.g., ice, dry ice or a gel pack, can be placed in the cavity in the box with the item being shipped.

EPS is relatively inexpensive and easily formed into a variety of shapes, but is not compostable. Similarly, plastics used for insulation are generally not recyclable. Consequently, disposing of the material of the container can be a problem.

### SUMMARY

A container is described that provides for thermal insulation of an item being shipped while the components are still recyclable or compostable.

In one aspect, a panel that can be assembled into a container includes a unitary outer wall formed of recyclable plant-fiber pulp and pre-cut to be folded into a box, and one or more pads laminated to the outer wall and covering portions of the outer wall that when folded into the box provide sidewalls and floor of the box such that the pads cover interior surfaces of the sidewalls of the box. Each pad includes a thermally insulative layer of starch and/or cellulose and/or plant fiber pulp.

Implementations may include one or more of the following features.

The outer wall may be corrugated fiberboard. The outer wall may be a substantially planar sheet of compressed plant-fiber pulp.

The pad may include a solid slab of starch and/or cellulose. The slab may be bonded to the outer wall. An outer liner formed of plastic or plant fiber pulp may be positioned between the slab and the outer wall, with the slab bonded to the outer liner and the outer liner bonded to the outer wall.

A bag formed of plastic or plant fiber pulp may surround the slab. The bag may wraps around the slab and provide both an interior surface of the pad and an exterior surface of the pad facing the outer wall. The bag may be a compostable bioplastic. The slab may be loose within the bag. The bag may be bonded to the outer wall. An outer liner formed of plastic or plant fiber pulp may be positioned between the bag and the outer wall, and the bag may be bonded to the outer liner and the outer liner may be bonded to the outer wall.

The pad may include a bag formed of plastic or plant fiber pulp surrounding loose fill starch and/or cellulose. The bag is bonded to the outer wall. An outer liner formed of plastic or plant fiber pulp may be positioned between the bag and the outer wall, and the bag may be bonded to the outer liner, and the outer liner may be bonded to the outer wall. An inner liner composed of plastic or plant fiber pulp may be bonded to a surface of the bag farther from outer wall.

An inner liner composed of plastic or plant fiber pulp may be bonded to a surface of the pad farther from outer wall, the inner liner bonded to the pad. The inner liner may be paper. The outer wall may be corrugated fiberboard.

An outer liner composed of plastic or plant fiber pulp may be positioned between the pad and the outer wall, the pad may be bonded to the outer liner, and the outer liner may be bonded to the outer wall.

The inner surface of the outer wall may include portions that are not covered by the one or more pads. The outer wall may include four side wall portions, two inner bottom flaps, and two outer bottom flaps, and the outer bottom flaps may not be covered by the one or more pads. The outer wall may include two inner top flaps and two outer top flaps, and the outer top flaps may not be covered by the one or more pads.

The one or more pads laminated to the outer wall may be a single pad covering all of the portions of the outer wall that when folded into the box provide the sidewalls and the floor of the box. The one or more pads laminated to the outer wall may include a plurality of pads covering the portions of the outer wall that when folded into the box provide the sidewalls and the floor of the box.

Potential advantages may include (and are not limited to) one or more of the following.

The container is compostable or street-side recyclable, and thus easily disposable while reducing landfill. If the outer sheet is recyclable, e.g., formed of thick non-compostable cardboard, then the starch or cellulose insulating material can dissolve easily during the recycling process. This makes the container compatible with existing paper-recycling techniques, such that the entire container can be fed into a paper-recycling process without having to separate the outer sheet from the insulating material.

The interior of the container can have a film, e.g., a water-retardant film, that covers the starch or cellulose insulating material, to protect the insulting material from liquid, e.g., condensation.

The container can provide equivalent thermal insulation to expanded polystyrene, and can be disposed in commercial and residential composting or recycling bins or garbage cans. The container can be shipped flat and can be easily assembled by the user.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1A is a schematic top view of an implementation of the insulated container in an unfolded state as a flat panel.

FIG. 1B is a schematic perspective view of the container when folded into a box.

FIG. 2 is a schematic cross-sectional view of a portion of the panel that forms the container.

FIG. 3 is a schematic top view of an outer wall in an unfolded state.

FIG. 4A is a schematic cross-sectional view of a portion of one implementation of the outer wall.

FIG. 4B is a schematic cross-sectional view of a portion of another implementation of the outer wall.

FIG. 4C is a schematic cross-sectional view of a portion of another implementation of the outer wall.

FIG. 5A is a schematic top view of one implementation of the container in an unfolded state with an insulating layer attached to portions of the outer wall in an unfolded state.

FIG. 5B is a schematic top view of another implementation of the container in an unfolded state with an insulating layer attached to portions of the outer wall in an unfolded state.

FIG. 6 is a schematic cross-sectional view of an implementation of a pad having a scribe line.

FIG. 7A is a schematic perspective view of an implementation of a pad.

FIG. 7B is a schematic cross-sectional view of a portion of the pad of FIG. 7A.

FIG. 8A is a schematic perspective view of another implementation of a pad.

FIG. 8B is a schematic cross-sectional view of the pad of FIG. 8A.

FIG. 9 is a schematic perspective view of a corrugated slab.

FIG. 10 is a schematic illustration of a method of fabricating the pad of FIG. 8A.

FIG. 11A is a schematic cross-sectional view showing multiple stacked slabs of insulating material.

FIG. 11B is a schematic cross-sectional view showing multiple stacked slabs of insulating material in bag in a folded position.

FIG. 12 is a schematic cross-sectional view showing multiple slabs of insulating material laminated together.

FIG. 13 is a schematic cross-sectional view showing multiple stacked slabs arranged side-by-side in a bag.

FIG. 14A is a schematic perspective view of another implementation of a pad.

FIG. 14B is a schematic cross-sectional view of the pad of FIG. 14A.

FIG. 15A is a schematic cross-sectional view of a portion of one implementation of the liner.

FIG. 15B is a schematic cross-sectional view of a portion of another implementation of the liner.

FIG. 15C is a schematic cross-sectional view of a portion of another implementation of the liner.

FIG. 16 is a schematic cross-sectional view of a portion of another implementation of the panel that forms the container.

FIG. 17 is a schematic top view of another implementation of an insulated container in an unfolded state as a flat panel.

FIG. 18 is a schematic top view of another implementation of an insulated container in an unfolded state as a flat panel.

FIG. 19 is a schematic top view of another implementation of an insulated container in an unfolded state as a flat panel.

FIG. 20 is a schematic cross-sectional view of a portion of another implementation of the panel that forms the container.

FIG. 21A is a schematic top view of a portion of another implementation of a panel that forms the container.

FIG. 21B is schematic cross-sectional view of the panel of FIG. 21A.

Like reference symbols in the various drawings indicate like elements.

### DETAILED DESCRIPTION

Initially, some terminology may be beneficial. “Biodegradable” simply means that a product will eventually disintegrate into innocuous material. “Recyclable” indicates that a product can be reused or treated in order to be made suitable for reuse. While many materials could be recycled by special processes, “street-side recyclable” indicates materials commonly permitted to be disposed in street-side residential or business recycling bins for collection and recycling by municipal waste disposal agencies (i.e., as of 2018). “Compostable” indicates both that a product will decompose quickly, e.g., within 180 days, and that the product will decompose into material that can be used as fertilizer (e.g., per ASTM D6400 or EN 13432). Products that are “biodegradable” need not be (and usually aren't) “compostable.” First, since there is no particular time limit for a “biodegradable” product to disintegrate, it need not decompose quickly. For example, even aluminum cans will biodegrade given several centuries. Moreover, even a biodegradable product that decomposes quickly might not provide a material that is suitable as fertilizer.

Most conventional thermally insulating materials for packaging, e.g., EPS, are not compostable.

A container having at least some thermal insulative capability can be formed from a foldable outer wall of a compostable or street-side recyclable material, e.g., a corrugated cardboard or a sheet of compressed plant fiber pulp. The outer wall can be substantially pure paper, or can be primarily paper but mixed with other materials. The paper can be formed from wood pulp, but the paper can include other plant fiber pulps, e.g., hemp, linen or cotton.

Secured to the inner surface (i.e., a surface toward the interior of the container when folded into a box) of the foldable outer wall is a pad that includes a compostable or street-side recyclable insulating material. In particular, the pad can include starch or cellulose. This insulating material can be a solid panel. In this case, the pad can be only, i.e., consist of, the panel of starch and/or cellulose. Alternatively, the pad can be provided by starch and/or cellulose material in loose form, e.g., pellets or fibers, contained in a compostable or street-side recyclable bag. Optionally the solid panel can be enclosed in a bag to provide the panel. The bag can be a plastic film such as polyethelyne, a paper, or bioplastic, e.g., a bioplastic that meets ASTM D6400 standards. The pad can consist of the starch and/or cellulose and the bag.

Optionally, the interior surface (i.e., a surface toward the interior of the container when folded into a box) of the pad, e.g., the interior surface of the insulating material or bag, can be covered with a compostable or street-side recyclable film, e.g., a plastic film such as polyethelyne, a paper, or bioplastic, e.g., a bioplastic that meets ASTM D6400 standards.

The film can be coated with or contain a moisture barrier, which can be a compostable or street-side recyclable material. The water-retardant materials can include water-resistant, water-repellent, or water-proof materials. For example, water-retardant materials include rubber, polyvinyl chloride, polyurethane, silicon elastomer, fluoropolymers, and wax. The water-retardant materials can prevent liquid, e.g., condensation, from passing through the film.

In some implementations, the container is entirely compostable, i.e., consists of compostable materials. In some implementations, the container is entirely street-side recyclable, i.e., consists of street-side recyclable materials. In some implementations, the container is formed of a combination of compostable and street-side recyclable materials.

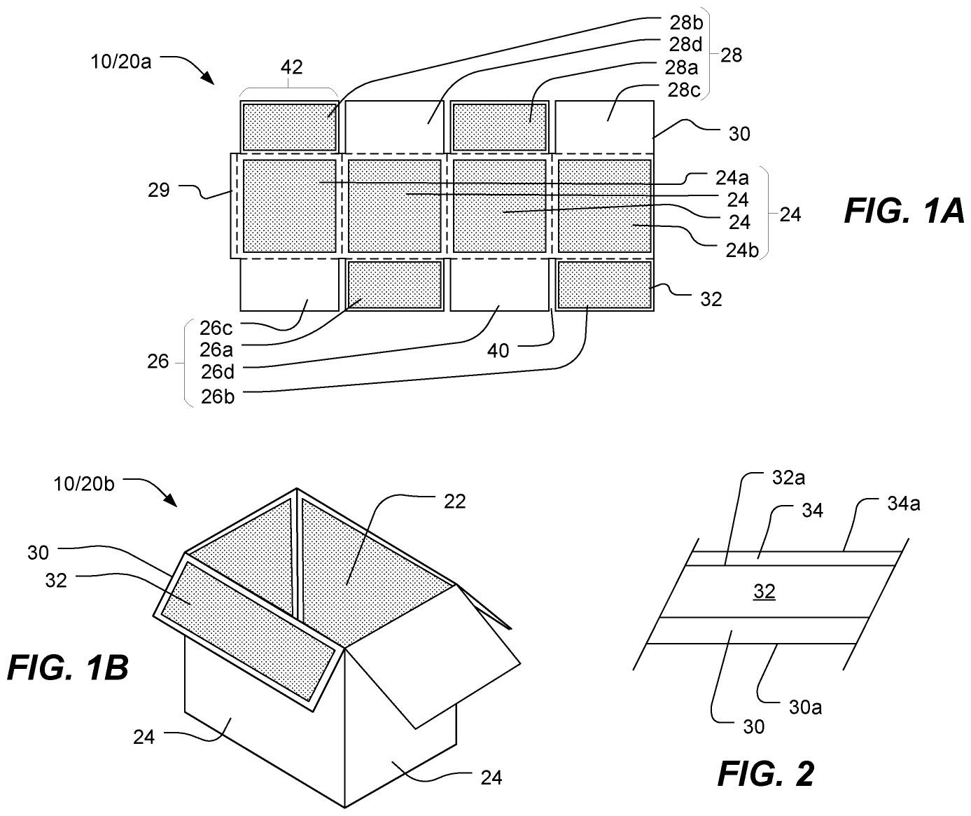

FIG. 1A is a top view of an implementation of the insulated container 10 in an unfolded state as a flat panel 20a. FIG. 1B is a perspective view of the container 10 when folded into a box 20b. The box 20b can be a rectangular prism, and can includes rectangular side walls 24 that define an interior cavity 22.

Edges of two of the side walls can be connected by an adhesive. For example, a flap 29 may extend from a portion 24a of the panel 20a that provides one side wall, and the flap can be secured, e.g., by an adhesive, to a portion 24b that provides another sidewall 24b.

The bottom of the box 20b may be closed off by one or more flaps 26 (not shown in FIG. 1B due to the perspective view).

The top of the box 20 provides an opening to the interior cavity 22. A cover for the box 20 can be provided by one or more flaps 28 that can be folded inwardly from the side walls 24 to close off the top of the cavity 22.

In some implementations, the side walls 24, and flaps 26 and 28 are all part of a single body that is folded into an appropriate shape. Alternatively, the side walls 24 and flaps 26 are part of a single body, but the cover for the box 20 can be provided by a separate lid.

A plurality of slots 40 can be cut into the edges of the panel 20a to define the portions of the container that will provide the flaps 26 and/or 28. For example, FIG. 1A illustrates an implementation in which three slots 40 cut into each of two opposite edges of the panel 20a. These slots divide the panel 20a into four sub-panels 42, each of which corresponds to a side wall 24 and two attached flaps 26 and 28.

To assemble the panel 20a shown in FIG. 1A into the box 20b shown in FIG. 1B, the panel 20a can be folded along a midline of the panel, and the flap 29 is secured to the portion 24b, e.g., by adhesive. Then the portions that provide the sidewalls can be separated to form an open rectangular shape. The two of the bottom flaps 26a, 26b from two opposing edges can be folded inward. Then the other two bottom flaps 26c, 26d can be folded inward to cover the two inner bottom flaps 26a, 26b. The two outer bottom flaps 26c, 26d can be secured, e.g., with tape, e.g., shipping tape, masking tape, duct tape, etc. This provides the box 20b with an open top as shown in FIG. 1B.

Next two of the top flaps 28a, 28b from two opposing edges can be folded inward. Then the other two top flaps 28c, 28d can be folded inward to cover the two inner top flaps 28a, 28b. The two outer top flaps 28c, 28d can be secured, e.g., with tape, e.g., shipping tape, masking tape, duct tape, etc.

Fold lines are illustrated in FIG. 1A by the phantom lines. In some implementations, the panel 20a is scored along the fold lines to make folding easier.

It should be noted that FIGS. 1A, 3 and 5A, illustrate just one configuration of a panel 20a that can be folded into a box, and many other configurations are possible. In general, the techniques described are applicable to panels that can be folded into a square or rectangular boxes, and to RSC (regular slotted carton) boxes, HSC (half slotted container) boxes, AFM (all flaps meet) boxes, FOL (full overlap) boxes, etc.

For example, FIG. 17 illustrates another panel 20a that can be folded into a box. In this case, portions of the panel 20a that provide the adjacent side walls 24 would need to be secured, e.g., by tape (but each side wall 24 would be continuously joined to the floor 26).

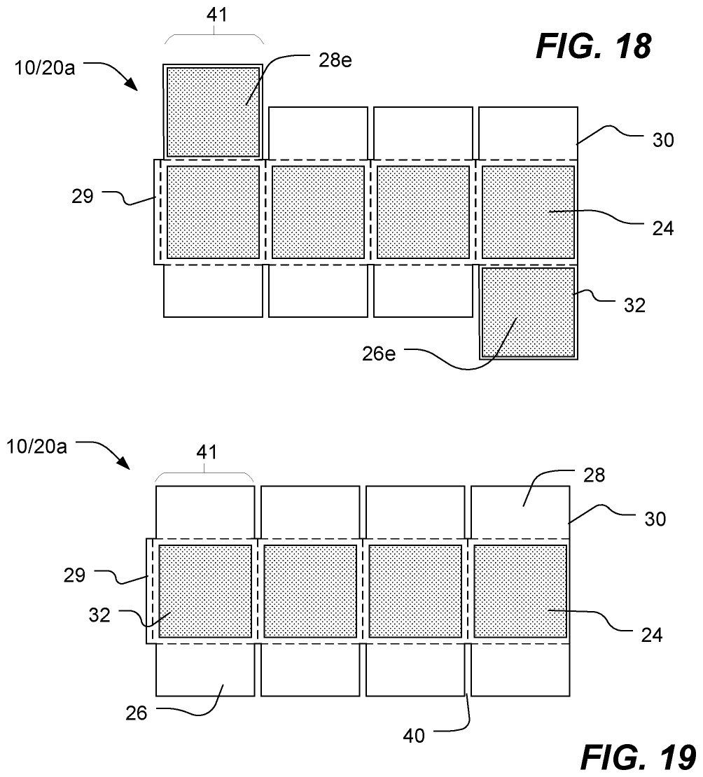

As another example, FIG. 18 illustrates a panel 20a in which one of the lower flaps 26e and one of the upper flaps 28e are long enough to fit entirely across the box 20a (instead of across half of the box as shown in FIG. 1A). Those flaps 26e, 28e are covered by a pad 32; the other flaps do not need be covered by pads. These flaps 26e, 28e can be folded in first so that the pads 32 are not covered by the other flaps. This configuration can be beneficial in that the insulating pad 32 does not have a break at the midline of the floor or ceiling, and thus can have superior thermal insulation.

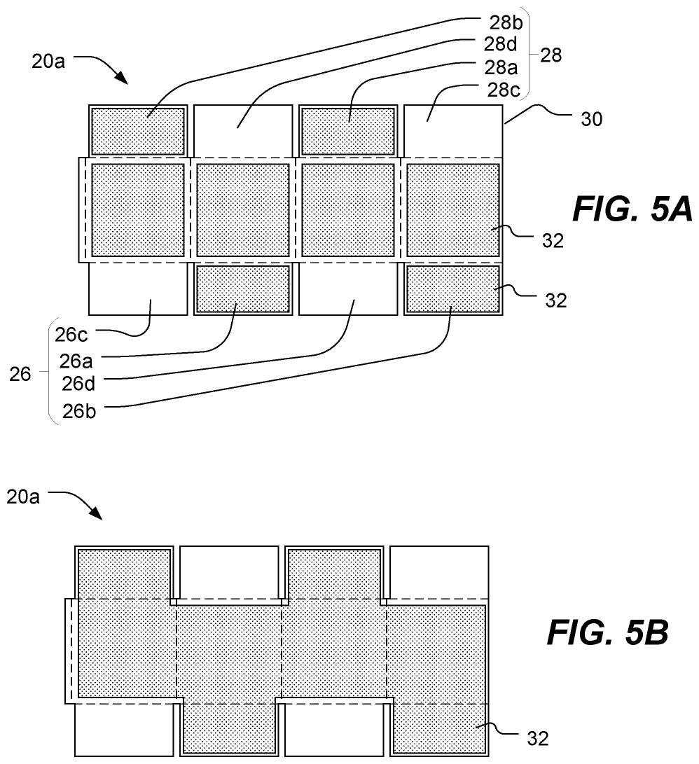

In addition, FIGS. 1A, 5A and 5B illustrate just one configuration for the positions of the pads, and other configurations are possible. For example, referring to FIG. 19, the lower flaps 26 and/or upper flaps 28 could not be covered by pads, so that the assembled box does not have the insulating material on the floor and/or ceiling.

The panel 20a can be shipped to customers in a completely unfolded state. In this case, an adhesive strip with a liner can be placed on the flap 29. On receipt, the customer can remove the liner and secure the flap 29 to the portion 24b. Alternatively, the panel 20a can be folded over along a midline with the flap 29 secured by an adhesive to the portion 24b before being shipped to the customer. In this case, the panel as shipped is still flat, but is twice the thickness (and half the length) as compared to the completely unfolded panel.

Referring to FIG. 2, the panel 20a that provides the container 10 is a laminated structure that includes an outer wall 30, a pad 32 containing starch or cellulose as a thermally insulating material, and optionally an inner liner 34 that covers the pad 32. An outer surface of the outer wall 30 will provide the outer surface of the box 20b, whereas an inner surface 32a of the pad 32 or an inner surface 34a of the liner 34 will provide the inner surface of the box 20b.

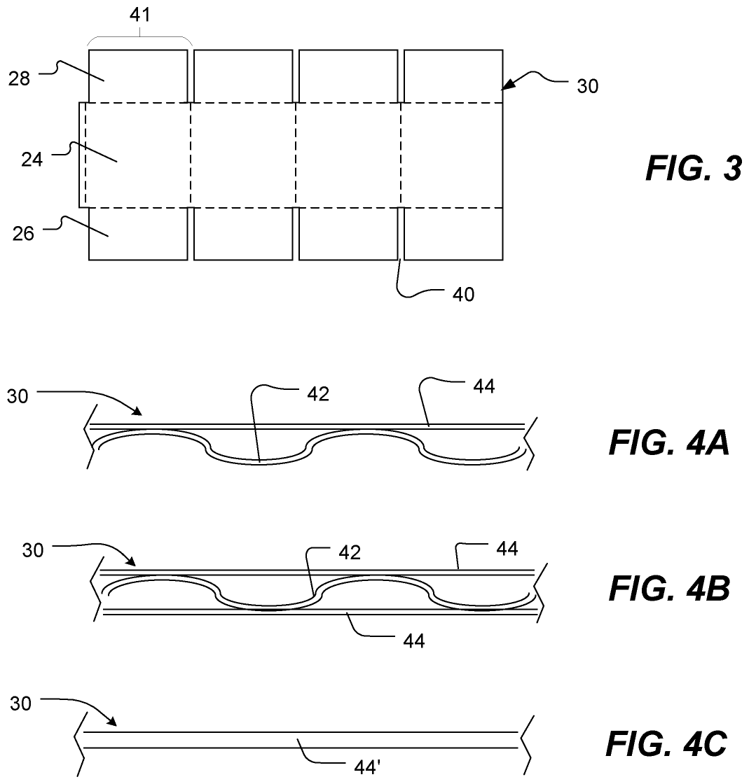

Referring to FIG. 3, the outer wall 30 is formed of a compostable or street-side recyclable material. The outer wall 30 has a stiffness comparable to cardboard.

The outer wall 30 can have the same shape as the panel 20a. For example, the plurality of slots 40 can be cut into the edges of the outer wall 30 to define the portions of the outer wall 30 that will provide the flaps 26 and/or 28. The slots 40 can be cut before or after other layers, e.g., the starch or cellulose layer 32 and/or the liner 34, is laminated onto the outer wall 30.

Each sub-panel 41 can be continuously joined to an adjacent sub-panel 41. In this context, “continuous” indicates that the portions are joined without a discontinuity in material composition; there is no gap, adhesive, melted region, or similar disruption in the material composition to indicate a seam. Thus, when assembled into the box 20b, two adjacent side walls (corresponding to portions 24a and 24b, see FIG. 1) are joined with an adhesive, but the remaining pairs of adjacent sidewalls 24 are joined continuously.

The outer wall 30 can be corrugated fiberboard, i.e., a fluted corrugated sheet 42 that is either attached to a planar sheet 44 (see FIG. 4A) or sandwiched between two planar sheets 44 (see FIG. 4B), all of which are formed of a plant-fiber pulp based material. A thickness of the fiberboard can be between about 0.01 and 0.25 inch, e.g., 0.05 inches. A thickness of the sheets in the corrugated fiberboard can be 0.005 and 0.05 inch, e.g., 0.01 inches. The fluted layer 42 can have flutes with a depth of 0.02 to 0.2 inches. One of the planar sheets 44 can provide the bottom surface of the panel 20a (and the outside of the box 20a when the container is folded). If the outer wall is corrugated fiberboard with a single a fluted corrugated sheet 72, then the pad 32 can be attached to the fluted corrugated sheet 72.

Alternatively, the outer wall 30 can simply be a single homogenous sheet 44′ (see FIG. 4C) that is relatively thick (compared to the thickness of the sheets in corrugated fiberboard) and is formed of a plant-fiber pulp based material. The single homogenous sheet 44′ can be substantially planar. A thickness of the single homogenous sheet can be between about 0.01 and 0.25 inch.

The sheet(s) 42 and/or 44 that provide either fiberboard or the single homogenous sheet can be substantially pure paper (be formed from wood pulp), or can be primarily paper but mixed with other materials. For example, the paper can include other plant fiber pulps, e.g., hemp, linen or cotton. Alternatively, the sheets can be formed primarily or entirely of a compressed plant fiber pulp other than paper. For example, the plant fibers could be fibers from coconut husk, corn husk, linen, cotton, bamboo or bagasse. In some cases, a combination of plant fibers from different plants can be used.

Referring to FIG. 5A, one or more pads 32 are secured to the outer wall 30. Each pad includes a compostable or street-side recyclable thermally insulating material. In particular, the pad 32 can include, e.g., consist of, a glucose-chain polymer, e.g., starch and/or cellulose.

The thermally insulating material can be formed primarily of starch, e.g., an extruded starch, and/or cellulose, e.g., an extruded cellulose, and/or compressed plant fibers, e.g., molded plant fiber pulp.

The starch can be a grain starch, e.g., corn starch, wheat starch or sorghum (sorghum is also known as milo), a root starch, e.g., potato starch, a vegetable starch, or combinations thereof. The plant fibers can be fibers of wood, hemp, linencoconut husk, corn husk, linen, cotton, bamboo or bagasse.

As starch and/or cellulose, the insulating material can form solid blocks of material, although the blocks could be porous. For example, the starch and/or cellulose could provide a solid matrix surrounding closed-cell pores.

As compressed plant fiber pulp, the insulating material can also form solid blocks of material, and the blocks can be porous. For example, the plant fiber pulp could provide a solid matrix surrounding closed-cell pores. Alternatively, as compressed plant fiber pulp, the insulating material can be a sheet of material that is wrinkled or crumpled to form open or closed-cell pockets.

The blocks of insulating material can be material, the insulating material can be ¼ to 3 inches thick. The sheets of insulating material can be 1/500 to 1/10 inches thick, although in the wrinkled or crumpled form they can have a similar thickness of ¼ to 3 inches.

Other materials that do not interfere with the compostable nature of the insulating material, e.g., a softener to improve adhesion, or a preservative or anti-fungal agent, can be present, but only in small quantities. For example, at least 85%, e.g., at least 90-95%, by weight of the insulating material is starch and/or cellulose. Polyvinyl alcohol can be present, e.g., 5-10% by weight.

If the insulating material is primarily starch, then the insulating material would be compostable. Moreover, the insulating material can dissolve easily during the recycling process. This makes the insulating material compatible with existing paper-recycling techniques, such that the entire container can be fed into a paper-recycling process without having to separate the outer sheet from the insulating material.

If the insulating material is primarily cellulose, then the insulating material would be compatible with existing paper-recycling techniques.

The insulating material has a different composition or structural integrity than the outer wall 30. For example, the outer wall 30 can be plant fiber pulp, whereas the insulating material can be starch. Or the outer wall 30 can be a first plant fiber pulp, e.g., paper pulp, whereas the insulating material can be a different second plant fiber pulp, e.g., pulp of fibers from coconut husk, corn husk, linen, cotton, bamboo or bagasse. Or the outer wall 30 can be a plant fiber pulp, e.g., paper pulp, fabricated by a first process, whereas the insulating material can be a plant fiber pulp, e.g., paper pulp, fabricated by a different second process that provides the insulating material with different degree of compression, pore density, etc., than the first process. For example, the outer wall could be formed by extrusion and drying, whereas the insulating material could be formed by molding.

The pad 32, e.g., the insulating material (either the slab 60 or the particles 64) can be more compressible than the outer wall 30. In addition, the pad 32, e.g., the insulating material (either the slab 60 or the particles 64) can be more flexible than the outer wall 30.

As illustrated in FIG. 5A, there can be a separate pad 32 for each respective portion of the outer wall 30 that corresponds to each respective side wall. In addition, pads 32 can be placed on two opposing bottom flaps 26. In particular, the pads 32 can be placed on the bottom interior flaps 26a and 26b, so that when assembled into the box 20b, the respective pads 32 are closer to the interior. In contrast, the other two opposing bottom flaps, e.g., the bottom exterior flaps 26c and 26d, do not have pads. Similarly, pads 32 can be placed on two opposing top flaps 26. In particular, the pads 32 can be placed on the top interior flaps 28a and 28b, so that when assembled into the box 20b, the respective pads 32 are closer to the interior. Conversely, the other two opposing bottom flaps, e.g., the exterior top flaps 28c and 28d, do not have pads.

By placing a separate pad for each portion of the outer wall, with the pads 32 slightly spaced apart, e.g., by 0.125 to 0.5 inches, the panel 20a can be folded into the box 20b even if the pads 32 are relatively thick.

However, it should be noted that FIG. 5A illustrates just one configuration that uses multiple pads 32, and many other configurations are possible. Some or all of the pads could be combined into a single pad. For example, FIG. 5B illustrates a panel another panel 20a that includes just a single pad 32 that covers the same regions on the outer wall 30. In addition, some of the pads 32 could be combined, e.g., the each sub-panel 42 could have a single pad that covers both the portion of the outer wall 30 corresponding to the side wall 24 and one of the flaps. Or there could be a single pad for all of the side walls, and separate pads for each flap. Of course, other configurations for the panel 20a (e.g., as shown in FIG. 17) can have other pad configurations.

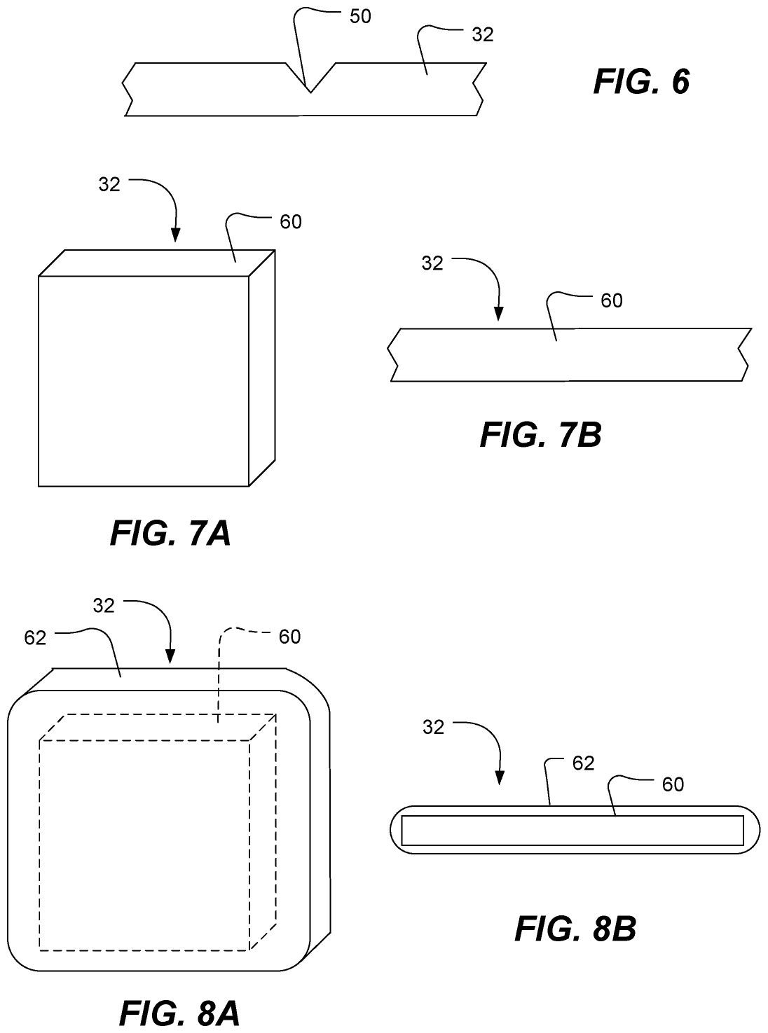

Optionally, the pad 32 can include scribe lines 50 (see FIG. 6), e.g., lines along the pad that are compressed or have material removed, to increase flexibility of the pad 32 so that the panel 20a that can be folded into a box 20b. The scribe lines can be positioned where the pad 32 spans a fold line on the outer wall 30.

Referring to FIGS. 7A and 7B, in some implementations the insulating material is provided as a solid slab 60. In this case, the pad 32 can be only, i.e., consist of, the slab of starch and/or cellulose. For example, as shown in FIG. 7A, the pad 32 can be a simple rectangular slab 60 (or a more complex but still flat slab, e.g., to conform to the outline shown in FIG. 5B).

In some implementations, the slab 60 is affixed directly to the outer wall 30. For example, the slab 60 can be secured to the outer wall 30 by an adhesive. The adhesive can be a separate additive, or the adhesive can be provided by applying water to a face of the slab to cause the starch or cellulose at the surface of the slab 60 to become tacky such that the slab 60 sticks to the outer wall 30.

Referring to FIGS. 8A and 8B, in some implementations the solid slab 60 of insulating material is enclosed in a bag 62 to provide the pad 32. In this case, the pad 32 can be only, i.e., consist of, the bag and the slab of starch and/or cellulose (and the air in the bag). The slab 60 can be a simple rectangular solid (or a more complex but still flat slab, e.g., to conform to the outline shown in FIG. 5B), and the bag 62 can generally conform to the shape of the slab 60.

The interior of the bag 62 can include a small amount of air. In some implementations, the air is vacuumed out before the bag 62 is sealed, so that the interior of the bag 62 is evacuated of air.

In the directions parallel to the primary surface of the slab 60, the pocket provided by the interior of the bag 62 can be up to about 0.5 inches larger on each side than the slab 60.

The slab 60 can sit loose within the bag 62, e.g., be able to slide within the bag 62. That is, the panel is not bonded or otherwise fixed to the film. For example, the film can be in sliding contact with the panel.

Alternatively, the slab 60 can attached to the bag. For example, the bag 62 can be secured to the slab 60 by heat bonding the bag to the slab 60. As another example, the bag 62 can be secured to the slab 60 by an adhesive. The adhesive can be a separate additive, or the adhesive can be provided by applying water to the slab to cause the starch or cellulose at the surface of the slab to become tacky such that the slab sticks to the bag.

Each slab 60 is relatively thin, e.g., about 0.25-4 inch thick, as compared to the length and width of the slab. The thickness of a slab 60 is considered to be along its narrowest dimension, whereas the length and width of the slab 60 are considered to be along the two directions along the primary face, perpendicular to the thickness.

Each slab is “solid”, which in this context indicates that the slab holds together as a single unit, rather than being formed of loose-fill pellets. It may be noted that compressed starch pellets would not form a solid part; upon removal of pressure the pellets would disassemble, and increased pressure only fractures or pulverizes the pellets. A solid slab of extruded starch and/or cellulose provides significant thermal insulation, while still being compostable.

A solid slab of extruded starch and/or cellulose provides significant thermal insulation, while still being compostable.

It is possible for the slabs to be a foam material, e.g., to include small pores or voids spread substantially uniformly through the panel. For example, 10-80% of the volume of the slab can be pores or voids, e.g., 25-75%, 25-50%, 10-25%, 50-75%. The maximum size of the pores or voids can be about 1 mm. Although the slab could be a foam material, it is generally incompressible. The density of a slab can be about 0.4-3.5 g/cm³, e.g., 0.6-1.0 g/cm³, 0.8-2.0 g/cm³, 1.0-3.5 g/cm³.

Each slab can be of a uniform homogenous composition. Furthermore, each slab can be a unitary body—that is the body of the panel holds together by itself without adhesives or fasteners to join multiple sections together to form the panel.

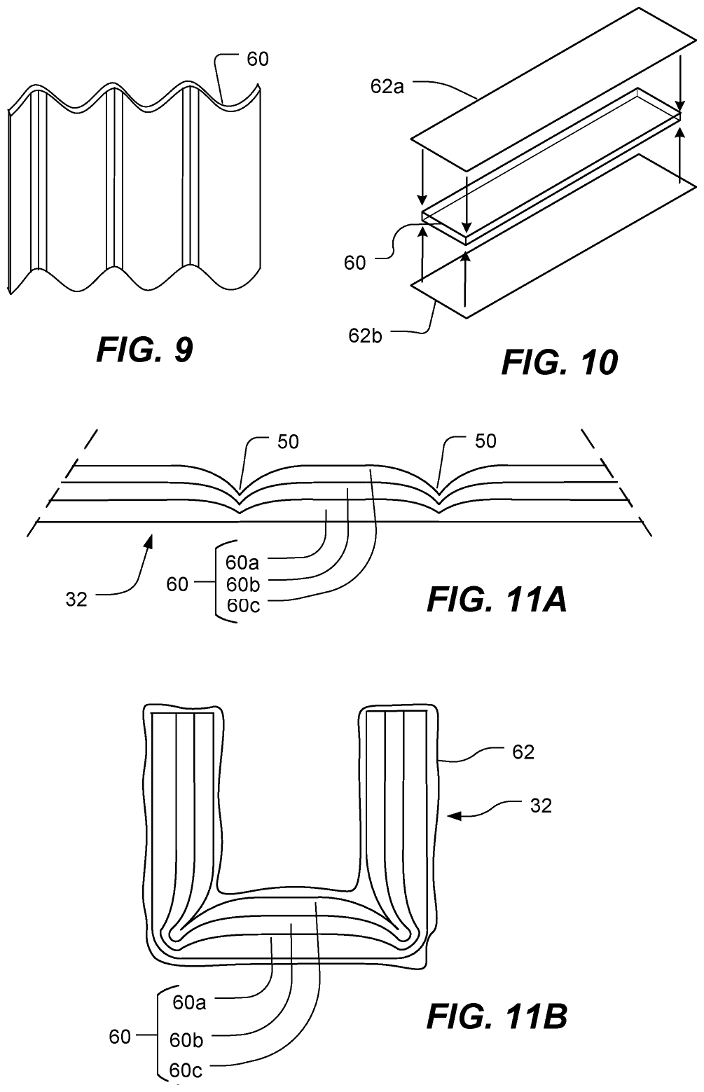

The thickness of a slab can be about ¼-3 inches, e.g., ¼-¾ inches. Any given slab can have substantially uniform thickness across its primary surface. The surfaces of the slab can be generally flat, or one or more surfaces can be corrugated (see FIG. 9). Corrugation can increase the effective thickness of the slab, e.g., by a factor of up to 4. In this case, the thickness of the slab can still be uniform, but the slab is shaped with corrugations.

Each slab 60 can be formed by an extrusion process, e.g., if a starch material. Alternatively, each slab 60 can be formed by a molding process, e.g., if a plant fiber pulp material. After extrusion, each slab can be cut to the appropriate size. In addition, the edges can optionally be beveled.

Other than one or slabs 50, there need not be any other thermally insulating material within the bag 62. For example, unless one of the slabs fractures due to applied stress, there are no loose pellets or pieces of other insulating material in the volume enclosed by the bag. In some implementations, the pad 32 consists of, i.e., includes only, one or more slabs, the bag, optionally some adhesive to secure the slabs to the bag or to each other, and optionally some air inside the volume enclosed by the film.

The bag 62 can be a plastic film such as polyethelyne, or a bioplastic, e.g., a bioplastic that meets ASTM D6400 standards, or a flexible paper.

In some implementations, the bag 62 is compostable, e.g., a bioplastic that meets ASTM D6400 standards. Suitable materials for a compostable film include polymers based on one or more of polylactic acid (PLA), poly(beta-amino) esters (PBAE), polyhydroxyalkanoate (PHA), polycapralactones (PCL), polybutyrate adipate terephthalate (PBAT) polyvinylalcohol (PVA), or ethylene vinyl alcohol (EVOH). For example, a combination of PBAT and PE may be suitable. As another example, a combination of PE and PLA may be suitable. In some implementations, the polymer can be mixed with an organic product, e.g., a starch, such as corn starch.

In some implementations, the film is recyclable and biodegradable. A suitable material for the recyclable film is polyethylene. For example, the film can be a low-density polyethylene (LDPE), a medium-density polyethylene (MDPE) or a high-density polyethylene (HDPE). An advantage of polyethylene is ease of fabrication and good water resistance.

A problem with starch-based insulation is that it dissolves easily in water. If the item being shipped is cold or a coolant is placed in the interior of the container 10, condensation can form on the interior surfaces of the pad 30. However, the bag 62 prevents liquid, e.g., the condensation, from reaching the starch or cellulose, thus enabling the starch or cellulose to be usable as a thermal insulator in the container.

Referring to FIG. 10, to fabricate a pad 32 that includes the slab 60 inside the bag 62, the slab 60 can be placed between two sheets of film 62a, 62b. The edges of the sheets of film 62a, 62b can be heat-sealed to each other, e.g., along the entire perimeter of the slab 60, thus enclosing and sealing the slab 60 in a pocket of the film that has only slightly larger dimension than the slab itself. A suitable sealing temperature is above 100° C. Excess film outside the heat seal can be cut away.

Alternatively, the film can be provided in a tubular form. To fabricate a pad 30, the panel is slid inside the tube of the film, and the two open ends of the tube are heat sealed. This forms a pocket in which the panel sits.

The bag 62 can be affixed directly to the outer wall 30. For example, the bag 62 can be secured to the outer wall 30 by an adhesive.

In some implementations, a pad 32 includes only one slab 60. However, referring to FIGS. 11A and 11B, in some implementations, the pad 32 includes multiple slabs 60. The slabs 60 are stacked along their thickness direction, and not arranged side-by-side. This permits fabrication of a thicker pad 32, thus increasing the thermal insulating capability. For example, this permits the total thickness of the pad 32 to be about 1-4 inches. In addition, avoiding gaps between that would occur with side-by-side panels can improve thermal insulation. In the example shown in FIG. 11A, there are three slabs 60a, 60b and 60c, but there could be just two slabs or four or more slabs.

For a pad 32 that spans a fold line of the outer wall 30, when the slabs 60 can be scored. The scoring 50 can be performed by compressing the stack of panels along a line (rather than cutting the panels). As a result, in the scored region some of the panels can be driven partially into the underlying panel.

For a pad 32 that spans a fold line of the outer wall 30, each slab 60 can be shorter than the slab immediately underneath to compensate for the stacking arrangement. This permits the ends of slabs 60 to substantially aligned when folded (e.g., as shown in FIG. 11B). In addition, the ends of the sections at the end of each slab be cut at an angle. For example, so that when the pad 32 is folded inwardly, the ends of the slabs 60 align.

In the various implementations discussed above, the individual slabs 60 will rest on one another within the pocket provided by the bag 62. However, the slabs 60 are not fixed to each other, e.g., the slabs are not secured by adhesive or interlocking components to each other.

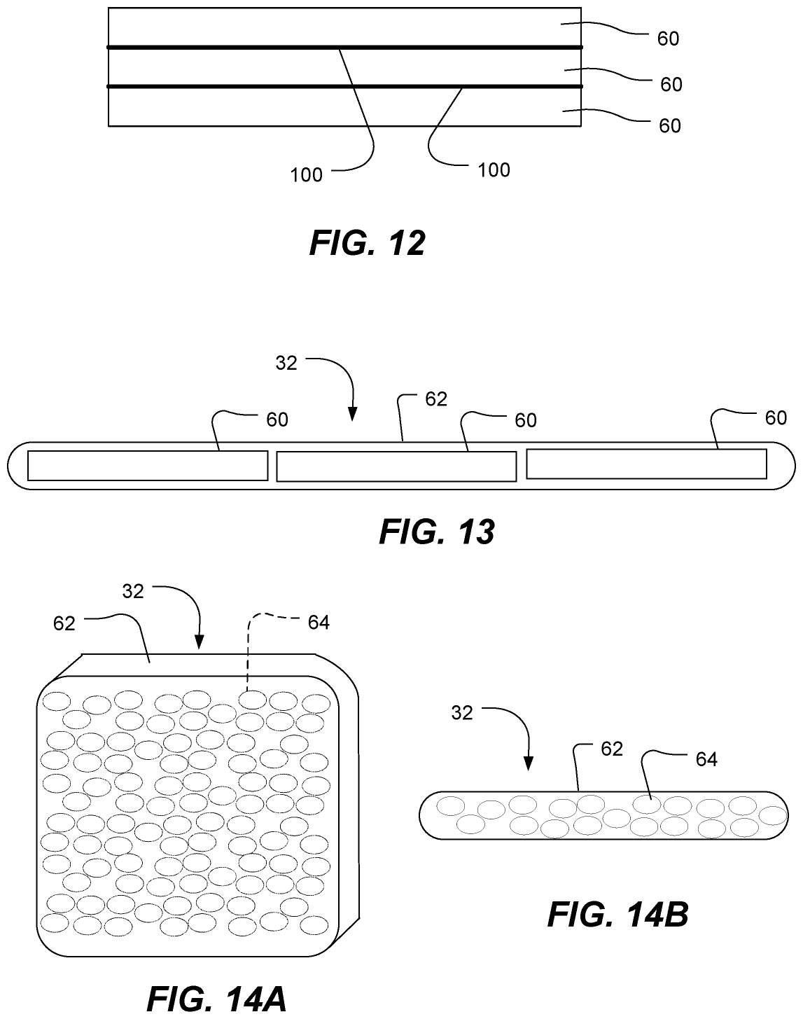

Referring to FIG. 12, although in some implementations multiple panels can be stacked without being joined, it is also possible for multiple slabs 60 to be stacked and laminated together. This can increase the total thickness of the resulting pad, e.g., to 1 to 3 inches thick. The slabs 60 can be joined by a thin layer of compostable adhesive 100.

For a pad 32 that spans a fold line of the outer wall 30, when the slabs 60 can be scored. The scoring 50 can be performed by compressing the stack of slabs along a line (rather than cutting the panels). As a result, in the scored region some of the slabs can be driven partially into the underlying slab.

Referring to FIG. 13, in some implementations, a pad 32 includes multiple slabs 60 arranged side-by-side in the bag 62. This permits the pad 32 to span multiple regions of the panel 20a (e.g., multiple side walls 24, and/or both a side wall and a flap) while being easy to fold. The gaps between the panels can correspond to the fold lines of the outer wall 30. In the example shown in FIG. 13, there are three slabs 60a, 60b and 60c, but there could be just two slabs or four or more slabs.

Rather than a solid slab, the pad can be provided by starch and/or cellulose material in loose form, e.g., pellets or fibers, contained in a compostable or street-side recyclable bag. Referring to FIGS. 14A and 14B, the loose particles 64 of insulating material, e.g., pellets or fibers, are enclosed in the bag 62 to provide the pad 32. In this case, the pad 32 can be only, i.e., consist of, the bag and the loose particles of starch and/or cellulose (and the air in the bag). The bag 62 can be secured to the outer wall, as described above. The particles can have a maximum dimension of about ⅛-2 inches.

The pad 32 can be attached to the outer wall 30 along the entire exterior surface of the pad 32. For example, an adhesive layer can span the exterior surface of the pad 32. However, in some implementations, rather than being attached to the entirety of the pad 32, the outer wall 30 is attached to either the pad 32 only along the edges of pad 32. Returning to FIG. 2, the optional liner 34 can be attached to, e.g., laminated onto, the interior surface 32a of the pad 32. There can be one liner for each pad 32, or there can be liners that cover multiple pads 32, or there can be a single liner that covers all the portions of the outer wall 30 that are covered by one or more pads 32, or there can be a single liner that covers the entire interior surface of the panel 20a.

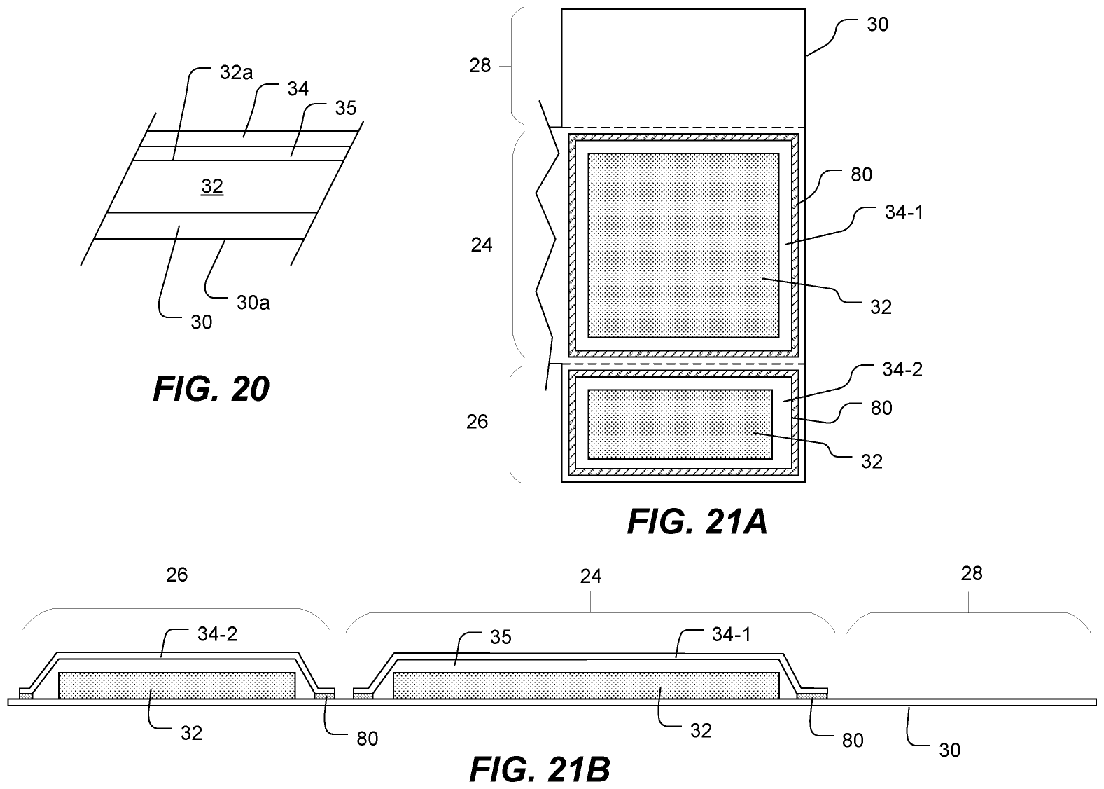

Rather than being attached to the pad 32, the liner 34 can sit loose on top of the pad 32. In this case, a thin air gap 35 (see FIG. 20) may be present between the liner 34 and pad 32 in some areas.

As shown in FIG. 2, the liner 34 is attached to the pad 32 along the entire surface of the pad 32. However, in some implementations, rather than being attached to the entirety of the pad 32, the liner 34 is attached to either the pad 32 or directly to the outer wall 30 only along the edges of pad 32.

For example, referring to FIGS. 21A and 21B, a first liner 34-1 is attached, e.g., by adhesive 80, directly to the outer wall 30 along the perimeter of the portion of the outer wall 30 that provides the side wall 34. In addition, a second liner 34-2 is attached, e.g., by adhesive 80, directly to the outer wall 30 along the perimeter of the portion of the outer wall 30 that provides one of the flaps, e.g., the bottom flap 26. This permits the formation of an air gap 35 between the pad 32 and the liner 34. The liners 34 thus provide pockets that enclose the pads 32. This permits the pads to be protected from the content placed in the interior 22 of the box 20a.

Of course, many alternative configurations are possible to attach the liner 34. For example, the liner can be attached directly to the pad 32 along the perimeter of the pad 32. As another example, there can be a single liner that spans multiple portions of the outer wall, e.g., the portions that provide both the side wall 24 and the flap 26, and the single liner can secured to the outer wall 30 or the pad 32 along the perimeter of the respective portions, or only along the perimeter of the liner 34 (e.g., not secured where the liner 34 spans a fold line). FIG. 21B illustrates the liner 34 as not covering portions of the outer wall 30 that do not have a pad, e.g., flap 28. However, the liner(s) 34 could cover portions of the outer wall 30 that do not have a pad.

The liner 34 can be a plant fiber pulp material, e.g., paper. The liner 34 can be a plastic, e.g., polyethylene. The liner can be compostable or street-side recyclable.

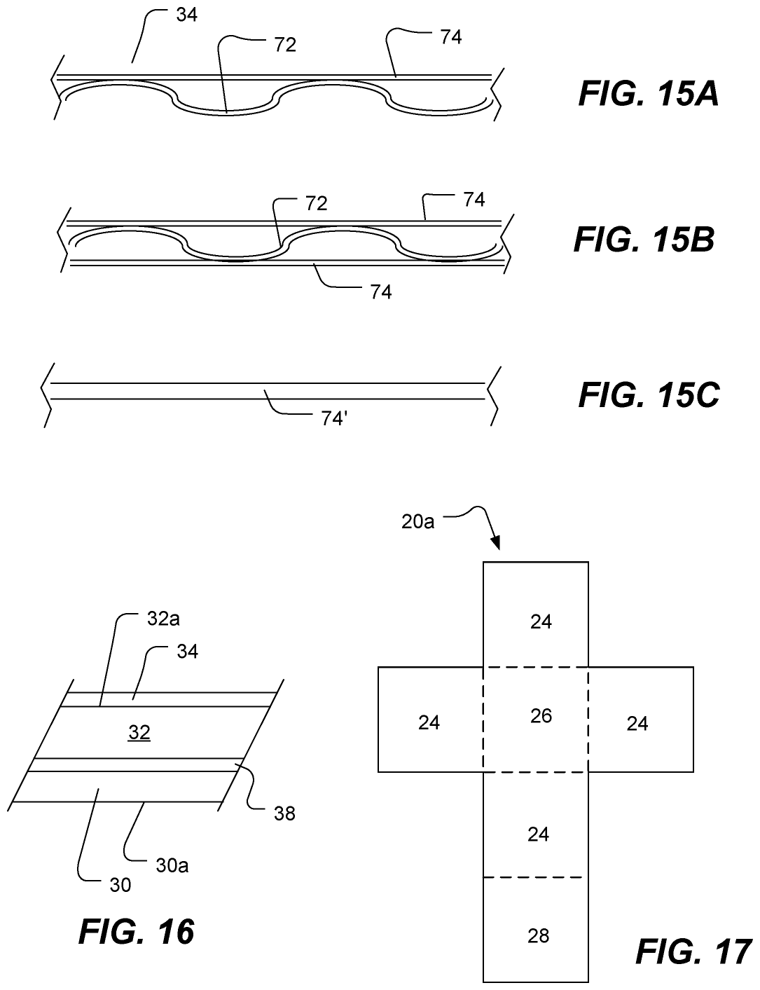

In some implementations, the liner 34 can be corrugated fiberboard, i.e., a fluted corrugated sheet 72 that is either attached to a planar sheet 74 (see FIG. 15A) or sandwiched between two planar sheets 74 (see FIG. 15B), all of which are formed of a plant-fiber pulp based material. A thickness of the fiberboard can be between about 0.01 and 0.25 inch, e.g., 0.05 inches. A thickness of the sheets in the corrugated fiberboard can be 0.005 and 0.05 inch, e.g., 0.01 inches.

Alternatively, the liner 34 can simply be a single homogenous sheet 74′ (see FIG. 4C) formed of a plant-fiber pulp based material. The single homogenous sheet 44′ can be substantially planar. A thickness of the single homogenous sheet can be between about 0.01 and 0.25 inch.

The sheet(s) 72 and/or 74 that provide either fiberboard or the single homogenous sheet of the liner 34 can be substantially pure paper (be formed from wood pulp), or can be primarily paper but mixed with other materials. For example, the paper can include other plant fiber pulps, e.g., hemp, linen or cotton. Alternatively, the sheets can be formed primarily or entirely of a compressed plant fiber pulp other than paper. For example, the plant fibers could be fibers from coconut husk, corn husk, linen, cotton, bamboo or bagasse. In some cases, a combination of plant fibers from different plants can be used.

Alternatively, the liner 34 can be a single homogenous sheet 74′ formed of a plastic, e.g., polyethylene. The single homogenous sheet 74′ can be substantially planar. The sheet 74′ of plastic can have a thickness between about 0.01 and 0.25 inch.

The outer wall 30 can be thicker than the liner 34. The liner 34 can be more flexible than the outer wall 30.

In some implementations, the liner 34 is coated with a coating of one or more water-retardant materials such that liquid, e.g., the condensation, cannot pass through the liner 34. The coating can be applied by spraying onto the paper, pouring a liquid onto the paper and curing, or forming a separate layer of the coating and bonding the coating, e.g., by heat, to the paper.

In some implementations, the liner 34 can be primarily formed of plant fiber mixed with the water-retardant materials.

The water-retardant materials for the liner 34 can be those described above for the bag 32.

Referring to FIG. 16, in some implementations, in addition to or instead of the liner 34, a liner 38 is disposed between the outer wall 30 and the pad 32. In this case, the liner 34 is attached, e.g., laminated, to the outer wall 30, and the pad 32 is attached, e.g., laminated, to the liner 38. The liner 38 can be composed as described above for the liner 34. The liner 38 on the exterior surface of the pad 32 can protect the insulating material of the pad 32 from the environment, e.g., moisture from outside the box 20b.

As described above, in some implementations, the liner 34 (and 38) is street-side recyclable or compostable such that the entire container 10 is street-side recyclable or compostable. Thus, a user can easily dispose of the container without separating the liner 34 from the pad 32.

Where all the components of the container 10 are compostable, the entire container can be disposed of as a unit in a composting bin. Where the outer wall 30 is recyclable panel and the pad 32 is compostable, the pad can be ripped off the outer wall manually by the recipient of the package, and then the pad can be disposed of in a composting bin and the outer wall 30 can be disposed of a recycling bin. Alternatively, the entire container can be disposed of as a unit in a recycling bin.

It should be understood that although various terms such as “top”, “bottom”, “vertical” and “lateral” are used, these terms indicate relative positioning of components under the assumption that an opening to the box 20 is at the top, and don't necessarily indicate an orientation relative to gravity; in use, or even during assembly, the container 10 could be on its side or upside down relative to gravity. The term “slightly” indicates no more than about 5%, e.g., no more than 2%.

A number of embodiments have been described. Nevertheless, it will be understood that various modifications may be made without departing from the spirit and scope of the invention. Accordingly, other embodiments are within the scope of the following claims.

1. A panel for assembly into a container, the panel comprising:
a unitary outer wall formed of recyclable plant-fiber pulp and pre-cut to be folded into a box;
one or more pads laminated to the outer wall and covering portions of the outer wall that when folded into the box provide sidewalls and floor of the box such that the pads cover interior surfaces of the sidewalls of the box, each pad including a thermally insulative layer of starch and/or cellulose and/or plant fiber pulp, wherein the pad includes a solid slab of starch and/or cellulose, and wherein the slab is bonded directly to the outer wall along at least a portion of a first face of the slab; and
one or more inner liners formed of plastic or plant fiber pulp, each liner covering an opposite second face of a respective slab and bonded to the outer wall such that the liner surrounds a perimeter of the respective slab.

2. The panel of claim 1, wherein the outer wall is corrugated fiberboard.

3. The panel of claim 1, wherein the outer wall is a substantially planar sheet of compressed plant-fiber pulp.

4-11. (canceled)

12. The panel of claim 1, wherein the inner liner is bonded to a surface of the pad farther from the outer wall.

13. The panel of claim 12, wherein the inner liner is paper.

14. The panel of claim 12, wherein the outer wall is corrugated fiberboard.

15-17. (canceled)

18. The panel of claim 1, wherein the inner surface of the outer wall includes portions that are not covered by the one or more pads.

19. The panel of claim 18, wherein the outer wall comprises four side wall portions, two inner bottom flaps, and two outer bottom flaps, and wherein the outer bottom flaps are not covered by the one or more pads.

20. The panel of claim 19, wherein the outer wall comprises two inner top flaps and two outer top flaps, and wherein the outer top flaps are not covered by the one or more pads.

21. The panel of claim 1, wherein the one or more pads laminated to the outer wall comprise a single pad covering all of the portions of the outer wall that when folded into the box provide the sidewalls and the floor of the box.

22. The panel of claim 1, wherein the one or more pads laminated to the outer wall comprise a plurality of pads covering the portions of the outer wall that when folded into the box provide the sidewalls and the floor of the box.

23. The panel of claim 1, wherein the insulative material includes an anti-fungal agent.

24. The panel of claim 1, wherein the slab is more flexible than the outer wall.

25. The panel of claim 1, wherein the slab includes small pores or voids spread substantially uniformly through the panel.

26. The panel of claim 1, wherein the slab is secured to the outer wall by an adhesive.

27. The panel of claim 26, wherein the adhesive is provided by applying water to a face of the slab to cause the slab to become tacky.

28. The panel of claim 1, wherein the slab spans a fold line of the outer wall and the slab is scored.

29. The panel of claim 12, wherein the inner liner is bonded to the second face of the slab.

30. The panel of claim 1, wherein the inner liner is separated from the second face of the slab by an air gap.
